(19) United States
(12) Patent Application Publication
(10) Pub. No.: US 2026/0370014 A1
(43) Pub. Date: Nov. 19, 2026

(54) POWER CONTROL SYSTEM AND POWER CONTROL METHOD

(71) Applicant: ASUSTEK COMPUTER INC., TAIPEI (TW)

(72) Inventors: Chun TSAO, TAIPEI (TW); Chun-Yen LAI, TAIPEI (TW); Hui-Chuan LO, TAIPEI (TW); Yi-Sheng CHIU, TAIPEI (TW); Kuo-Cheng HE, TAIPEI (TW); Chia-Hung CHANG, TAIPEI (TW); Sheng-Chao LEE, TAIPEI (TW)

(21) Appl. No.: 19/346,030

(22) Filed: Sep. 30, 2025

(30) Foreign Application Priority Data
May 16, 2025 (TW) 114118516

(51) Int. Cl. H02J 7/50; H02J 7/82; H02J 7/90

(52) U.S. Cl. CPC H02J 7/50; H02J 7/825; H02J 7/933

(57) ABSTRACT

A power control method, applicable to an electronic device, is provided. The electronic device is provided with a first battery module and a second battery module. A first maximum charging voltage value and a first maximum charging current value correspond to the first battery module are obtained, and a second maximum charging voltage value and a second maximum charging current value correspond to the second battery module are obtained. Whether the first battery module and the second battery module are not fully charged is determined. When both the first battery module and the second battery module are not fully charged, a smaller one of the first maximum charging voltage value and the second maximum charging voltage value is set as a charger charging voltage value. The first battery module and the second battery module are charged based on the charger charging voltage value. A power control system is further provided.

### CROSS-REFERENCE TO RELATED APPLICATION

This application claims the priority benefit of Taiwan application serial No. 114118516, filed on May 16, 2025. The entirety of the above-mentioned patent application is hereby incorporated by reference herein and made a part of the specification.

### BACKGROUND OF THE INVENTION

### Field of the Invention

The disclosure relates to a power control system and a power control method, and in particular, to a power control system and a power control method for electronic devices.

### Description of the Related Art

Most of conventional portable electronic devices, for example, notebook computers, are provided with a single battery pack for supplying power. However, design of the single battery pack is limited by an internal layout of the electronic device and is not easily enlarged. To overcome the problem of insufficient capacity of single battery pack is to dispose two battery packs inside a housing and used in parallel, which improves system space efficiency. However, when the two battery packs are used in parallel, control problems occur while charging and discharging.

### BRIEF SUMMARY OF THE INVENTION

The disclosure provides a power control method, applicable to an electronic device. The electronic device is provided with a first battery module and a second battery module, and includes a charger configured to charge the first battery module and the second battery module. The power control method includes the following steps. First, the first battery module obtains a first maximum charging voltage value and a first maximum charging current value that correspond to the first battery module, and the second battery module obtains a second maximum charging voltage value and a second maximum charging current value that correspond to the second battery module. Next, it is determined whether the first and second battery modules are not yet fully charged. When both the first battery module and the second battery module are not fully charged, a smaller one of the first maximum charging voltage value and the second maximum charging voltage value is set as a charger charging voltage value, and the charger is controlled, based on the charger charging voltage value, to charge the first battery module and the second battery module.

The disclosure further provides a power control system, applicable to an electronic device. The electronic device is provided with a first battery module and a second battery module. The power control system includes a charger and a microcontroller. The charger is configured to charge the first battery module and the second battery module. The microcontroller is electrically coupled to the first battery module, the second battery module, and the charger, and is configured to: obtain, from the first battery module, a first maximum charging voltage value and a first maximum charging current value that correspond to the first battery module; obtain, from the second battery module, a second maximum charging voltage value and a second maximum charging current value that correspond to the second battery module; determine whether the first battery module and the second battery module are not fully charged; set, when both the first battery module and the second battery module are not fully charged, a smaller one of the first maximum charging voltage value and the second maximum charging voltage value as a charger charging voltage value; and control, based on the charger charging voltage value, the charger to charge the first battery module and the second battery module.

In the power control method and the power control system that are provided in the disclosure, the microcontroller is used to obtain the first maximum charging voltage value and the first maximum charging current value that correspond to the first battery module, and the second maximum charging voltage value and the second maximum charging current value that correspond to the second battery module. When both the first battery module and the second battery module are not fully charged, the smaller one of the first maximum charging voltage value and the second maximum charging voltage value is set as the charger charging voltage value to charge the first battery module and the second battery module. In this way, a problem of an excessively high charging voltage can be avoided, and control problems of charging and discharging when two battery packs are used in parallel can be effectively resolved.

### BRIEF DESCRIPTION OF THE DRAWINGS

FIGS. 1A and 1B are schematic diagrams of a power control system according to an embodiment of the disclosure;

FIG. 2 is a flowchart of a power control method according to a first embodiment of the disclosure;

FIG. 3 is a flowchart of a power control method according to a second embodiment of the disclosure;

FIG. 4 is a flowchart of a power control method according to a third embodiment of the disclosure; and

FIG. 5 is a flowchart of a power control method according to a fourth embodiment of the disclosure.

### DETAILED DESCRIPTION OF THE EMBODIMENTS

More detailed descriptions of specific embodiments of the disclosure are provided below with reference to the schematic diagrams. The advantages and features of the disclosure are described more clearly according to the following descriptions and claims. It is to be noted that all of the drawings are in very simplified forms and in imprecise proportions, and are merely intended to assist in conveniently and clearly explaining the embodiments of the disclosure.

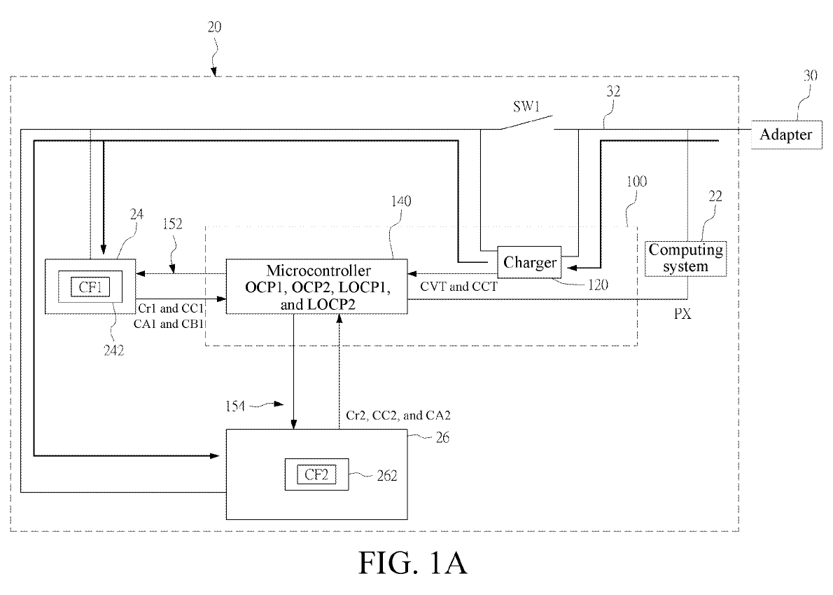

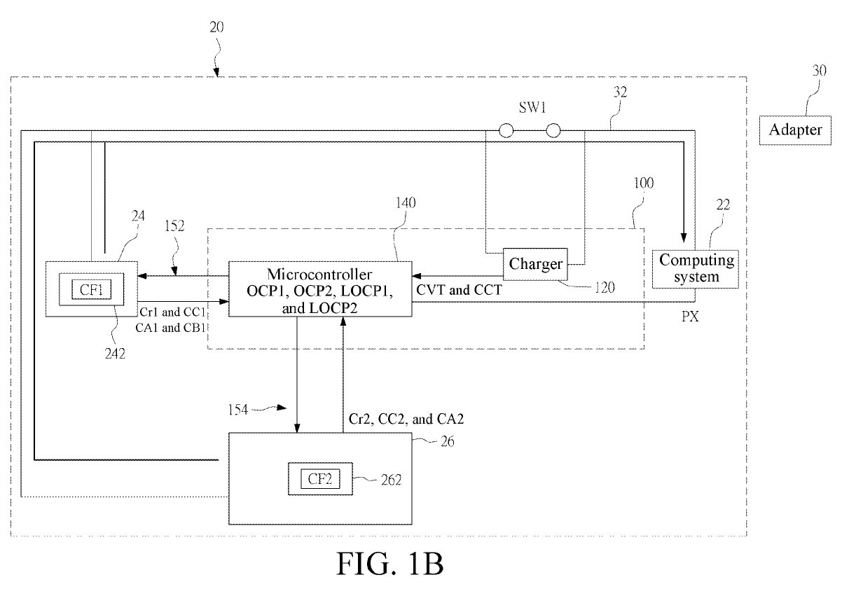

FIGS. 1A and 1B and are schematic diagrams of a power control system 100 according to an embodiment of the disclosure. FIG. 1A shows a schematic diagram of the power control system 100 in a battery charging state. FIG. 1B shows a schematic diagram of the power control system 100 in a battery discharging state. Bold arrows in the figure show a flow direction of a current.

As shown in the figure, the power control system 100 is applicable to an electronic device 20. The electronic device 20 is connected to an adapter 30 to obtain power. The electronic device 20 is provided with a computing system 22, a first battery module 24, and a second battery module 26. The computing system 22 includes a performance degradation level PX. In an embodiment, the electronic device 20 is a notebook computer. However, the disclosure is not limited thereto.

As shown in the figure, the power control system 100 includes a charger 120 and a microcontroller 140.

The adapter 30 is configured to be electrically connected to the first battery module 24 and the second battery module 26 through a charging circuit 32. The charging circuit 32 includes a charging switch SW1. In the battery charging state, the charger 120 controls the charging switch SW1 to be in a turn-off state. In this case, power generated by the adapter 30 is used for simultaneously charging, through the charger 120, the first battery module 24 and the second battery module 26. In the battery discharging state, the charger 120 controls the charging switch SW1 to be in a turn-on state. In this case, the first battery module 24 and the second battery module 26 simultaneously supply power to the computing system 22.

The microcontroller 140 is electrically coupled to the first battery module 24, the second battery module 26, and the charger 120, and is configured to: detect states of the first battery module 24 and the second battery module 26 to generate a charger charging voltage value CVT; and control, based on the charger charging voltage value CVT, the charger 120 to simultaneously charge the first battery module 24 and the second battery module 26.

The microcontroller 140 is configured to: obtain, from the first battery module 24, a first maximum charging voltage value CV1 and a first maximum charging current value CC1 that correspond to the first battery module 24; and obtain, from the second battery module 26, a second maximum charging voltage value CV2 and a second maximum charging current value CC2 that correspond to the second battery module 26. The microcontroller 140 is further configured to determine whether the first battery module 24 and the second battery module 26 are fully charged.

In an embodiment, the microcontroller 140 is connected to the first battery module 24 and the second battery module 26 through system management buses (SMBuses) 152 and 154, to determine whether the first battery module 24 and the second battery module 26 are not fully charged.

In an embodiment, the first battery module 24 includes a first battery fuel gauge IC (gauge IC) 242, and the second battery module 26 includes a second battery fuel gauge IC 262. The first battery fuel gauge IC 242 stores a first fully charged state mark CF1, and the second battery fuel gauge IC 262 stores a second fully charged state mark CF2. The microcontroller 140 access, through the system management buses 152 and 154, the first fully charged state mark CF1 of the first battery fuel gauge IC 242 and the second fully charged state mark CF2 of the second battery fuel gauge IC 262, to determine whether the first battery module 24 and the second battery module 26 are fully charged.

When the microcontroller 140 detects that both the first battery module 24 and the second battery module 26 are not fully charged, the microcontroller 140 sets a smaller one of the first maximum charging voltage value CV1 and the second maximum charging voltage value CV2 as the charger charging voltage value CVT. The charger 120 is configured to simultaneously charge, based on the charger charging voltage value CVT, the first battery module 24 and the second battery module 26. Detailed operation logic of the microcontroller 140 is described in more detail in subsequent paragraphs.

In an embodiment, when the microcontroller 140 detects that both the first battery module 24 and the second battery module 26 are not fully charged, the microcontroller 140 further sets a smaller one of the first maximum charging current value CC1 and the second maximum charging current value CC2 as a charger charging current value CCT. The charger 120 is configured to charge, based on the charger charging voltage value CVT and the charger charging current value CCT, the first battery module 24 and the second battery module 26.

In an embodiment, the microcontroller 140 is further configured to: obtain, from the first battery module 24, a first actual charging current value CA1 and a first actual discharging current value CB1 that correspond to the first battery module 24; obtain, from the second battery module 26, a second actual charging current value CA2 and a second actual discharging current value CB2 that correspond to the second battery module 26; and notify, based on the first actual charging current value CA1, the first actual discharging current value CB1, the second actual charging current value CA2, and the second actual discharging current value CB2, a first maximum continuous discharging current value OCP1 and a first lower limit discharging current value LOCP1 that are defaulted by the first battery module 24, and a second maximum continuous discharging current value OCP2 and a second lower limit discharging current value LOCP2 that are defaulted by the second battery module 26, the computing system 22 to adjust the performance degradation level PX thereof. In practice, a current value of the first battery module 24 is detected, and the first actual charging current value CA1 and the first actual discharging current value CB1 are distinguished based on different current directions. The same is also true of the second battery module 26.

In an embodiment, a positive current value is understood as the first actual charging current value CA1, a negative current value is understood as a discharging current, and an absolute value thereof is the first actual discharging current value CB1.

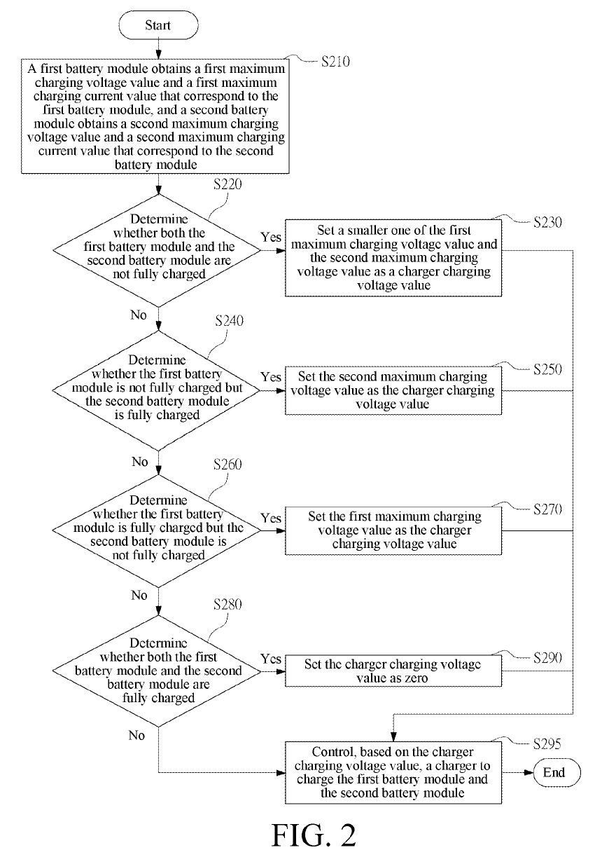

FIG. 2 is a flowchart of a power control method according to a first embodiment of the disclosure. In an embodiment, the power control method is applicable to the power control system 100 shown in FIG. 1. The power control method includes the following steps.

First, as described in step S210, a first battery module 24 obtains a first maximum charging voltage value CV1 and a first maximum charging current value CC1 that correspond to the first battery module 24, and a second battery module 26 obtains a second maximum charging voltage value CV2 and a second maximum charging current value CC2 that correspond to the second battery module 26.

Next, as described in a determining step S220, whether both the first battery module 24 and the second battery module 26 are not fully charged is determined. In an embodiment, the first battery module 24 includes a first battery fuel gauge IC 242, and the first battery fuel gauge IC 242 stores a first fully charged state mark CF1. When the first fully charged state mark CF1 is recorded as a number 0, it indicates that the first battery module 24 is not fully charged. When the first fully charged state mark CF1 is recorded as a number 1, it indicates that the first battery module 24 is fully charged. The second battery module 26 includes a second battery fuel gauge IC 262, and the second battery fuel gauge IC 262 stores a second fully charged state mark CF2. When the second fully charged state mark CF2 is recorded as a number 0, it indicates that the second battery module 26 is not fully charged. When the second fully charged state mark CF2 is recorded as a number 1, it indicates that the second battery module 26 is fully charged.

In the determining step S220, whether recorded numbers of the first fully charged state mark CF1 and the second fully charged state mark CF2 are both 0 is determined to determine whether both the first battery module 24 and the second battery module 26 are not fully charged.

When a determining result of the determining step S220 is yes, this process proceeds to step S230 of setting a smaller one of the first maximum charging voltage value CV1 and the second maximum charging voltage value CV2 as a charger charging voltage value CVT.

When the determining result of step S220 is no, this process proceeds to a determining step S240 of determining whether the first battery module 24 is not fully charged but the second battery module 26 is fully charged.

In an embodiment, in the determining step S240, whether the first fully charged state mark CF1 is 0 but the second fully charged state mark CF2 is 1 is determined to determine whether the first battery module 24 is not fully charged but the second battery module 26 is fully charged.

When a determining result of the determining step S240 is yes, this process proceeds to step S250 of setting the second maximum charging voltage value CV2 as the charger charging voltage value CVT.

When the determining result of the determining step S240 is no, this process proceeds to a determining step S260 of determining whether the first battery module 24 is fully charged but the second battery module 26 is not fully charged.

In an embodiment, in the determining step S260, whether the first fully charged state mark CF1 is 1 but the second fully charged state mark CF2 is 0 is determined to determine whether the first battery module 24 is fully charged but the second battery module 26 is not fully charged.

When a determining result of the determining step S260 is yes, this process proceeds to step S270 of setting the first maximum charging voltage value CV1 as the charger charging voltage value CVT.

When the determining result of the determining step S260 is no, this process proceeds to a determining step S280 of determining whether both the first battery module 24 and the second battery module 26 are fully charged.

In an embodiment, in the determining step S280, whether both the first fully charged state mark CF1 and the second fully charged state mark CF2 are 1 is determined to determine whether both the first battery module 24 and the second battery module 26 are fully charged.

When a determining result of the determining step S280 is yes, this process proceeds to step S290 of setting the charger charging voltage value CVT to zero.

After the charger charging voltage value CVT and a charger charging current value CCT are obtained, as described in step S295, a charger 120 is controlled to charge, based on the charger charging voltage value CVT, the first battery module 24 and the second battery module 26.

In this embodiment, although the determining result of the determining step S260 is no, the determining step S280 is further performed to determine whether both the first battery module 24 and the second battery module 26 are fully charged. However, the disclosure is not limited thereto. When all the determining results of the determining steps S220, S240, and S260 are no, it is determined that both the first battery module 24 and the second battery module 26 are fully charged. Therefore, in another embodiment, the determining step S280 can also be omitted, and when the determining result of the determining step S260 is no, step S290 is directly performed.

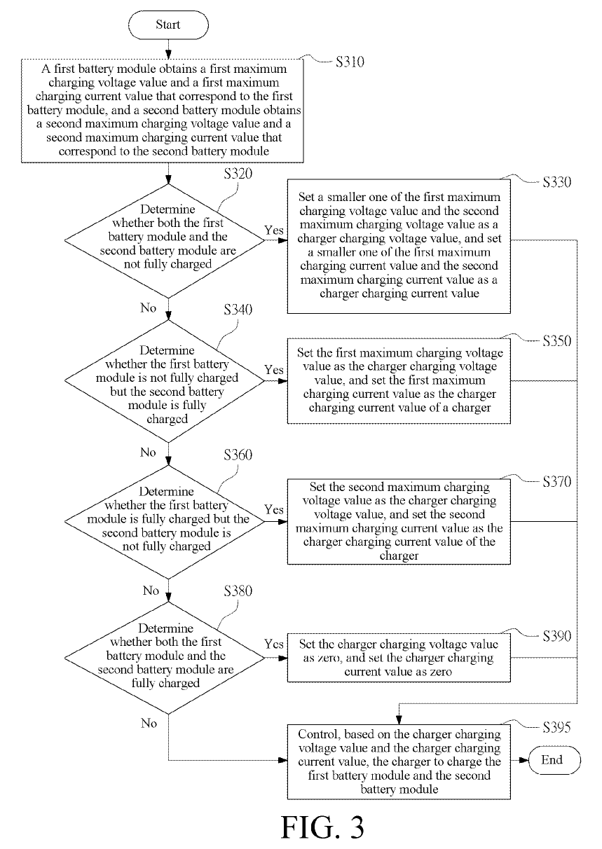

FIG. 3 is a flowchart of a power control method according to a second embodiment of the disclosure. In an embodiment, the power control method is applicable to the power control system 100 shown in FIG. 1. The power control method includes the following steps.

First, as described in step S310, a first battery module 24 obtains a first maximum charging voltage value CV1 and a first maximum charging current value CC1 that correspond to the first battery module 24, and a second battery module 26 obtains a second maximum charging voltage value CV2 and a second maximum charging current value CC2 that correspond to the second battery module 26.

Next, as described in a determining step S320, whether both the first battery module 24 and the second battery module 26 are not fully charged is determined.

When a determining result of the determining step S320 is yes, this process proceeds to step S330 of setting a smaller one of the first maximum charging voltage value CV1 and the second maximum charging voltage value CV2 as a charger charging voltage value CVT, and setting a smaller one of the first maximum charging current value CC1 and the second maximum charging current value CC2 as a charger charging current value CCT.

When the determining result of step S320 is no, this process proceeds to a determining step S340 of determining whether the first battery module 24 is not fully charged but the second battery module 26 is fully charged.

When a determining result of the determining step S340 is yes, this process proceeds to step S350 of setting the first maximum charging voltage value CV1 as the charger charging voltage value CVT, and setting the first maximum charging current value CC1 as the charger charging current value CCT of a charger 120.

When the determining result of the determining step S340 is no, this process proceeds to a determining step S360 of determining whether the first battery module 24 is fully charged but the second battery module 26 is not fully charged.

When a determining result of the determining step S360 is yes, this process proceeds to step S370 of setting the second maximum charging voltage value CV2 as the charger charging voltage value CVT, and setting the second maximum charging current value CC2 as the charger charging current value CCT of the charger 120.

When the determining result of the determining step S360 is no, this process proceeds to a determining step S380 of determining whether both the first battery module 24 and the second battery module 26 are fully charged.

When a determining result of the determining step S380 is yes, this process proceeds to step S390 of setting the charger charging voltage value CVT to zero, and setting the charger charging current value CCT to zero.

After the charger charging voltage value CVT and the charger charging current value CCT are obtained, as described in step S395, the charger 120 is controlled to charge, based on the charger charging voltage value CVT and the charger charging current value CCT, the first battery module 24 and the second battery module 26.

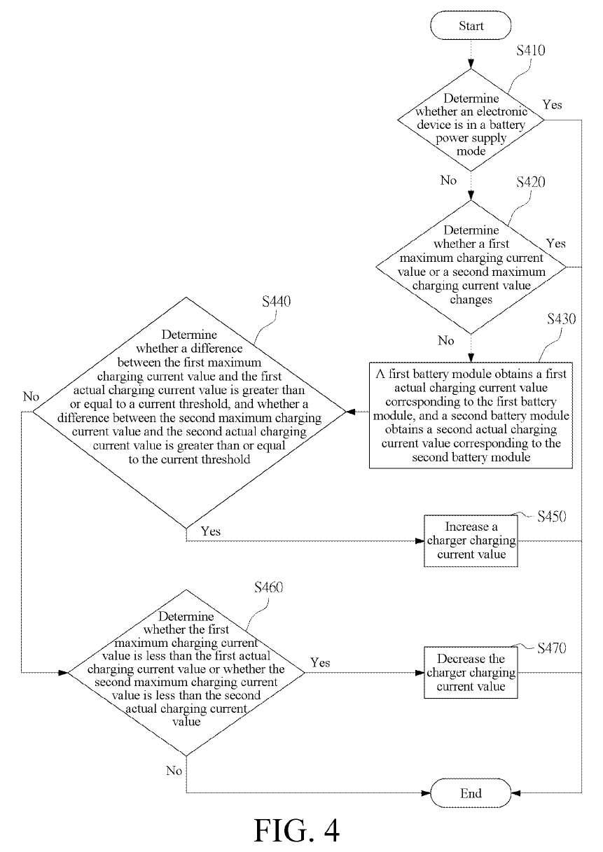

FIG. 4 is a flowchart of a power control method according to a third embodiment of the disclosure. In an embodiment, the power control method is applicable to the power control system 100 shown in FIG. 1. For the power control method, refer to step S330 in FIG. 3. The power control method includes the following steps.

First, as described in a determining step S410, whether an electronic device 20 is in a battery power supply mode is determined.

When a determining result of the determining step S410 is no, it indicates that the electronic device is connected to an adapter for charging. In this case, this process proceeds to a determining step S420 of determining whether a first maximum charging current value CC1 or a second maximum charging current value CC2 changes. When the determining result of the determining step S410 is yes, this process ends.

Following the determining step S420, when a determining result of the determining step S420 is no, this process proceeds to step S430 of obtaining, from the first battery module 24, a first actual charging current value CA1 corresponding to the first battery module 24, and obtaining, from the second battery module 26, a second actual charging current value CA2 corresponding to the second battery module 26.

When the determining result of the determining step S420 is yes, this process ends.

Following step S430, as described in a determining step S440, whether a difference between the first maximum charging current value CC1 and the first actual charging current value CA1 is greater than or equal to a current threshold, and whether a difference between the second maximum charging current value CC2 and the second actual charging current value CA2 is greater than or equal to the current threshold are determined. Magnitude of the current threshold is determined according to actual requirements. In an embodiment, the current threshold is set to 300 mA.

When a determining result of the determining step S440 is yes, this process proceeds to step S450 of increasing a charger charging current value CCT.

When the determining result of the determining step S440 is no, this process proceeds to a determining step S460 of determining whether the first maximum charging current value CC1 is less than the first actual charging current value CA1 or whether the second maximum charging current value CC2 is less than the second actual charging current value CA2.

When a determining result of the determining step S460 is yes, this process proceeds to step S470 of decreasing the charger charging current value CCT. When the determining result of the determining step S460 is no, this process ends.

In this way, when the first maximum charging current value CC1 is less than the first actual charging current value CA1 or the second maximum charging current value CC2 is less than the second actual charging current value CA2, in the power control method according to this embodiment, the charger charging current value CCT is decreased, to avoid a case in which a lifespan of a battery module is affected due to an excessively large actual charging current.

In an embodiment, the foregoing step (namely, step S450) of increasing the charger charging current value CCT is increasing the charger charging current value CCT based on an increased unit value, and the step (namely, step S470) of decreasing the charger charging current value CCT is decreasing the charger charging current value CCT based on a decreased unit value. A unit of the increased unit value and a unit of the decreased unit value are mA. In an embodiment, the increased unit value is greater than the decreased unit value, so that in the power control method according to this embodiment, a charging parameter of a charger 120 is quickly adjusted in response to a battery state. However, the disclosure is not limited thereto.

Further, in an embodiment, the foregoing determining step S440, that is, the step of determining whether the difference between the first maximum charging current value CC1 and the first actual charging current value CA1 is greater than or equal to the current threshold, and whether the difference between the second maximum charging current value CC2 and the second actual charging current value CA2 is greater than or equal to the current threshold, waits for a first preset time period and then makes the determining result. The foregoing determining step S460, that is, the step of determining whether the first maximum charging current value CC1 is less than the first actual charging current value CA1 or whether the second maximum charging current value CC2 is less than the second actual charging current value CA2, waits for a second preset time period and then makes the determining result. The first preset time period is greater than the second preset time period. In an embodiment, the foregoing first preset time period is two seconds, and the second preset time period is one second.

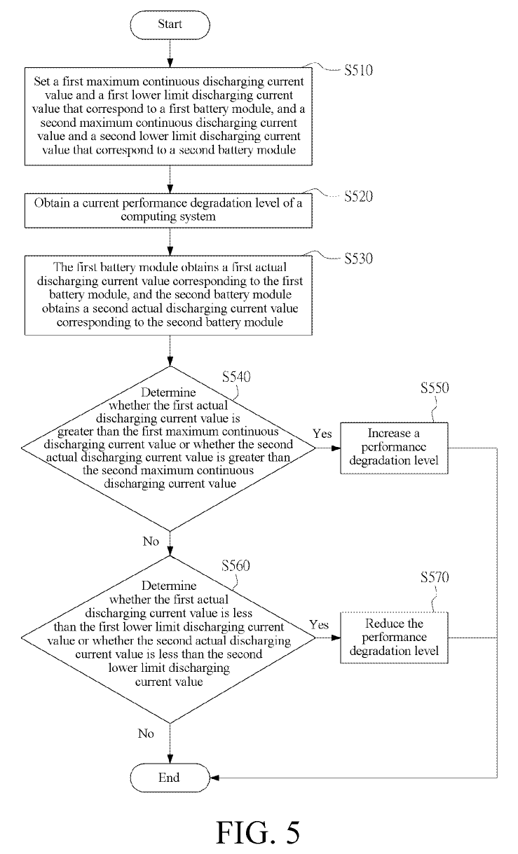

FIG. 5 is a flowchart of a power control method according to a fourth embodiment of the disclosure. In an embodiment, the power control method is applicable to the power control system 100 shown in FIG. 1. The power control method includes the following steps.

First, as described in step S510, a first maximum continuous discharging current value OCP1 and a first lower limit discharging current value LOCP1 that correspond to a first battery module 24, and a second maximum continuous discharging current value OCP2 and a second lower limit discharging current value LOCP2 that correspond to the second battery module 26 are set.

Subsequently, as described in step S520, a current performance degradation level PX of a computing system 22 is obtained. The performance degradation level PX is a frequency degradation level or a power consumption degradation level that corresponds to the computing system 22 (or a central processing unit).

The foregoing step S510 and step S520 are performed successively, or are simultaneously performed. Further, in another embodiment, a sequence of the foregoing step S510 and a sequence of step S520 are also exchangeable.

Next, as described in step S530, the first battery module 24 obtains a first actual discharging current value CB1 corresponding to the first battery module 24, and the second battery module 26 obtains a second actual discharging current value CB2 corresponding to the second battery module 26.

Subsequently, as described in a determining step S540, whether the first actual discharging current value CB1 is greater than the first maximum continuous discharging current value OCP1 or whether the second actual discharging current value CB2 is greater than the second maximum continuous discharging current value OCP2 is determined. In an embodiment, when specifications of the first battery module 24 and the second battery module 26 are the same, the foregoing first maximum continuous discharging current value OCP1 and the second maximum continuous discharging current value OCP2 are set to a same value.

When a determining result of the determining step S540 is yes, this process proceeds to step S550 of increasing the performance degradation level PX, to protect the first battery module 24 and the second battery module 26. When the determining result of the determining step S540 is no, this process proceeds to a determining step S560.

In this way, when the first actual discharging current value CB1 is greater than the first maximum continuous discharging current value OCP1 or the second actual discharging current value CB2 is greater than the second maximum continuous discharging current value OCP2, in the power control method according to this embodiment, the performance degradation level PX is increased, that is, performance or power consumption of the computing system 22 is reduced.

As described in the determining step S560, whether the first actual discharging current value CB1 is less than the first lower limit discharging current value LOCP1 or whether the second actual discharging current value CB2 is less than the second lower limit discharging current value LOCP2 is determined.

When a determining result of the determining step S560 is yes, this process proceeds to step S570 of reducing the performance degradation level PX. When the determining result of the determining step S560 is no, this process ends.

In this way, when the first actual discharging current value CB1 is less than the first lower limit discharging current value LOCP1 and the second actual discharging current value CB2 is less than the second lower limit discharging current value LOCP2, in the power control method according to this embodiment, the performance degradation level PX is reduced, that is, the performance or power consumption of the computing system 22 is increased.

In the foregoing step S540 and step S550, when it is determined that the first actual discharging current value CB1 is greater than the first maximum continuous discharging current value OCP1 or the second actual discharging current value CB2 is greater than the second maximum continuous discharging current value OCP2, the performance degradation level PX is increased. However, the disclosure is not limited thereto. In another embodiment, when it is determined that there is a case in which the first actual discharging current value CB1 is greater than the first maximum continuous discharging current value OCP1 or the second actual discharging current value CB2 is greater than the second maximum continuous discharging current value OCP2, whether the current performance degradation level PX is less than a maximum performance degradation level allowed by an electronic device 20 is further determined.

Similarly, in the foregoing step S560 and step S570, when it is determined that the first actual discharging current value CB1 is less than the first lower limit discharging current value LOCP1 or the second actual discharging current value CB2 is less than the second lower limit discharging current value LOCP2, the performance degradation level PX is reduced. However, the disclosure is not limited thereto. In another embodiment, when it is determined that there is a case in which the first actual discharging current value CB1 is less than the first lower limit discharging current value LOCP1 or the second actual discharging current value CB2 is less than the second lower limit discharging current value LOCP2, whether the current performance degradation level PX is higher than a minimum performance degradation level allowed by the electronic device 20 is further determined.

In the power control method and the power control system 100 that are provided in the disclosure, a microcontroller 140 is used to obtain a first maximum charging voltage value CV1 and a first maximum charging current value CC1 that correspond to the first battery module 24, and a second maximum charging voltage value CV2 and a second maximum charging current value CC2 that correspond to the second battery module 26. In addition, when both the first battery module 24 and the second battery module 26 are not fully charged, a smaller one of the first maximum charging voltage value CV1 and the second maximum charging voltage value CV2 is set as a charger charging voltage value CVT, and a smaller one of the first maximum charging current value CC1 and the second maximum charging current value CC2 is set as a charger charging current value CCT, and the first battery module 24 and the second battery module 26 are charged based on the charger charging voltage value CVT and the charger charging current value CCT. In this way, a case in which damage is caused to a battery due to an excessively high charging voltage or an excessively large charging current can be avoided, and a problem of charging and discharging control when two battery packs are used in parallel can be effectively resolved.

The foregoing descriptions are merely exemplary embodiments of the disclosure, and do not impose any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A power control method, applicable to an electronic device, wherein the electronic device is provided with a first battery module and a second battery module, and comprises a charger, configured to charge the first battery module and the second battery module, and the power control method comprising:
obtaining a first maximum charging voltage value and a first maximum charging current value that correspond to the first battery module from the first battery module, and obtaining a second maximum charging voltage value and a second maximum charging current value that correspond to the second battery module from the second battery module;
determining whether both the first battery module and the second battery module are not fully charged; and
when both the first battery module and the second battery module are not fully charged, setting a smaller one of the first maximum charging voltage value and the second maximum charging voltage value as a charger charging voltage value, and controlling the charger to charge the first battery module and the second battery module based on the charger charging voltage value.

2. The power control method according to claim 1, further comprising:
when both the first battery module and the second battery module are not fully charged, setting a smaller one of the first maximum charging current value and the second maximum charging current value as a charger charging current value, and controlling the charger to charge the first battery module and the second battery module based on the charger charging current value.

3. The power control method according to claim 2, further comprising:
obtaining a first actual charging current value corresponding to the first battery module from the first battery module, and obtaining a second actual charging current value corresponding to the second battery module from the second battery module; and
increasing the charger charging current value when a difference between the first maximum charging current value and the first actual charging current value is greater than or equal to a current threshold and a difference between the second maximum charging current value and the second actual charging current value is greater than or equal to the current threshold.

4. The power control method according to claim 3, wherein the step of increasing the charger charging current value is increasing the charger charging current value based on an increased unit value.

5. The power control method according to claim 2, further comprising:
obtaining a first actual charging current value corresponding to the first battery module from the first battery module, and obtaining a second actual charging current value corresponding to the second battery module from the second battery module; and
decreasing the charger charging current value when the first maximum charging current value is less than the first actual charging current value or the second maximum charging current value is less than the second actual charging current value.

6. The power control method according to claim 5, wherein the step of decreasing the charger charging current value is decreasing the charger charging current value based on a decreased unit value.

7. The power control method according to claim 1, wherein the electronic device comprises a computing system, the computing system is provided with a performance degradation level, and the power control method further comprising:
setting a first maximum continuous discharging current value corresponding to the first battery module and a second maximum continuous discharging current value corresponding to the second battery module;
obtaining a first actual discharging current value corresponding to the first battery module from the first battery module, and obtaining a second actual discharging current value corresponding to the second battery module from the second battery module; and
increasing the performance degradation level when the first actual discharging current value is greater than the first maximum continuous discharging current value or the second actual discharging current value is greater than the second maximum continuous discharging current value.

8. The power control method according to claim 7, further comprising:
setting a first lower limit discharging current value corresponding to the first battery module and a second lower limit discharging current value corresponding to the second battery module; and
reducing the performance degradation level when the first actual discharging current value is less than the first lower limit discharging current value and the second actual discharging current value is less than the second lower limit discharging current value.

9. The power control method according to claim 1, further comprising:
when the first battery module is fully charged but the second battery module is not fully charged, setting the second maximum charging voltage value as the charger charging voltage value, and setting the second maximum charging current value as a charger charging current value of the charger.

10. A power control system, applicable to an electronic device, wherein the electronic device is provided with a first battery module and a second battery module, and the power control system comprising:
a charger, configured to charge the first battery module and the second battery module; and
a microcontroller, electrically coupled to the first battery module, the second battery module, and the charger, and configured to:
obtain, a first maximum charging voltage value and a first maximum charging current value that correspond to the first battery module from the first battery module, and obtain a second maximum charging voltage value and a second maximum charging current value that correspond to the second battery module from the second battery module;
determine whether the first battery module and the second battery module are not fully charged; and
when both the first battery module and the second battery module are not fully charged, set a smaller one of the first maximum charging voltage value and the second maximum charging voltage value as a charger charging voltage value, and control the charger to charge the first battery module and the second battery module based on the charger charging voltage value.

11. The power control system according to claim 10, wherein the microcontroller is connected to the first battery module and the second battery module through a system management bus, to determine whether the first battery module and the second battery module are not fully charged.

12. The power control system according to claim 11, wherein the first battery module comprises a first battery fuel gauge IC, the second battery module comprises a second battery fuel gauge IC, the first battery fuel gauge IC stores a first fully charged state mark, the second battery fuel gauge IC stores a second fully charged state mark, and the microcontroller determines, based on the first fully charged state mark and the second fully charged state mark, whether the first battery module and the second battery module are not fully charged.
